(19) United States
(12) Patent Application Publication
(10) Pub. No.: US 2018/0229530 A1
(43) Pub. Date: Aug. 16, 2018

(54) CONTROL DEVICE, IMAGE PROCESSING APPARATUS AND METHOD FOR REALIZING EFFICIENCY USE OF ENERGY

(71) Applicants: KABUSHIKI KAISHA TOSHIBA, Tokyo (JP); TOSHIBA TEC KABUSHIKI KAISHA, Tokyo (JP)

(72) Inventor: Satoshi Iwamoto, Mishima Shizuoka (JP)

(21) Appl. No.: 15/451,627

(22) Filed: Mar. 7, 2017

(30) Foreign Application Priority Data
Feb. 10, 2017 (JP) 2017-023486

(51) Int. Cl. B41M 7/00; B41J 2/32

(52) U.S. Cl. CPC B41M 7/0009; B41M 7/009; B41J 2/32

(57) ABSTRACT

In accordance with an embodiment, a control device comprises a control module. The control module controls execution of several modes. The control module controls a heater to a first temperature range in response to designation of a print mode to execute the print mode in which an image is formed with non-decolorable first recording material or decolorable second recording material on a sheet and the image is fixed on the sheet with the heater. The control module controls the heater to a second temperature range higher than the first temperature range in response to an execution state of the print mode to execute an erasing mode in which an image formed with the second recording material is erased by heating of the heater.

### CROSS-REFERENCE TO RELATED APPLICATIONS

This application is based upon and claims the benefit of priority from Japanese Patent Application No. 2017-023486, filed Feb. 10, 2017, the entire contents of which are incorporated herein by reference.

### FIELD

Embodiments described herein relate generally to a control device, an image processing apparatus and a method for realizing efficiency use of energy.

### BACKGROUND

There is known an apparatus such as a decoloring apparatus or an image processing apparatus which decolors an image formed with a decolorable recording material (for example, a toner or an ink) to erase an image. In these apparatuses, it is necessary to heat a heater for decoloring and energy is consumed at the time of heating.

### DESCRIPTION OF THE DRAWINGS

FIG. 1 is a pattern view illustrating the main portion constitution of an image processing apparatus according to a first embodiment;

FIG. 2 is a block diagram illustrating the main portion circuit constitution of the image processing apparatus according to the first embodiment;

FIG. 3 is a flowchart illustrating a control processing according to the first embodiment by a CPU in FIG. 2;

FIG. 4 is a flowchart illustrating a control processing according to the first embodiment by the CPU in FIG. 2;

FIG. 5 is a pattern view illustrating the main portion constitution of an image processing apparatus according to the second embodiment; and

FIG. 6 is a flowchart illustrating a control processing according to the second embodiment by the CPU in FIG. 2.

### DETAILED DESCRIPTION

In accordance with an embodiment, a control device comprises a control module. The control module controls execution of several modes. The control module controls a heater to a first temperature range in response to designation of a print mode to execute the print mode in which an image is formed with a non-decolorable first recording material or a decolorable second recording material on a sheet and the image is fixed on the sheet with the heater. The control module controls the heater to a second temperature range higher than the first temperature range in response to an execution state of the print mode to execute an erasing mode in which an image formed with the second recording material is erased by heating of the heater.

Hereinafter, image processing apparatuses according to several embodiments are described with reference to the accompanying drawings.

### First Embodiment

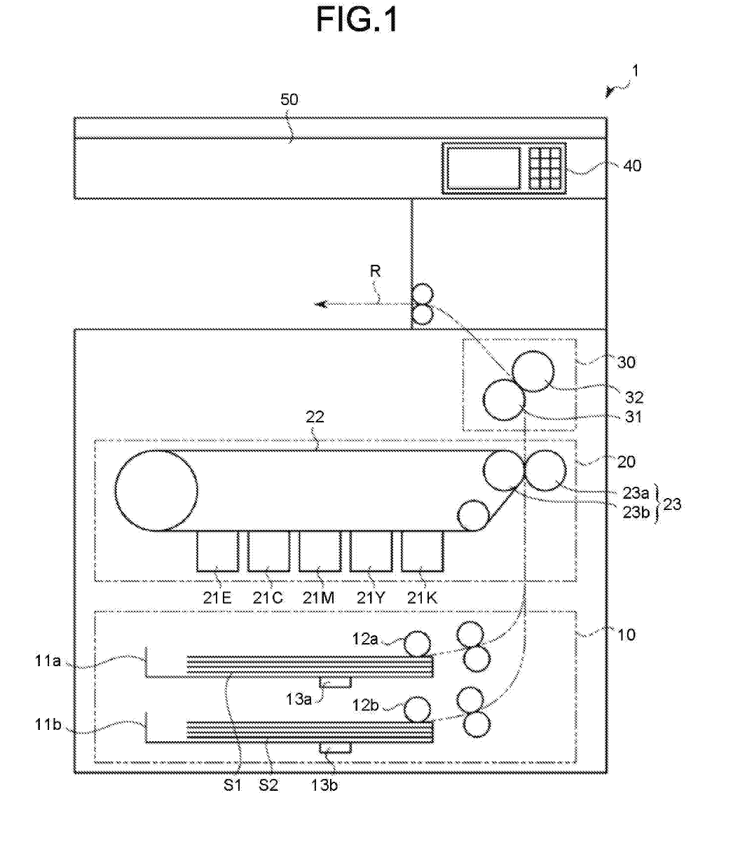

FIG. 1 is a pattern view illustrating the main portion constitution of an image processing apparatus 1 according to the first embodiment.

The image processing apparatus 1 can operate in a plurality of operation modes including a decoloring printing mode, a non-decoloring printing mode and a decoloring mode. The image processing apparatus 1 operating in the decoloring printing mode forms an image on a sheet such a paper and the like with a decolorable recording material. The image processing apparatus 1 operating in the non-decoloring printing mode forms an image on the sheet with a normal recording material (hereinafter, referred to as a “non-decolorable recording material”) that is not decolorable. The image processing apparatus 1 operating in the decoloring mode decolors the image formed with the decolorable recording material on the sheet. The image processing apparatus 1 includes a sheet feed section 10, a transfer section 20, a heating section 30, an operation panel 40 and a scanner section 50. The decoloring printing mode is an example of a print mode. The non-decoloring printing mode is an example of the print mode. The decoloring mode is an example of an erasing mode. The non-decolorable recording material is an example of a first recording material. The decolorable recording material is an example of a second recording material.

The sheet feed section 10 houses a paper used for printing or decoloring to supply the paper. The sheet feed section 10 includes a decoloring sheet tray 11a, a printing sheet tray 11b, a sheet feed roller 12a, a sheet feed roller 12b, a sheet detection sensor 13a and a sheet detection sensor 13b.

The decoloring sheet tray 11a houses a decoloring sheet S1 on which an image is formed with the decolorable recording material. A user of the image processing apparatus 1 puts a sheet desired to be decolored in the decoloring sheet tray 11a in advance. The image on the decoloring sheet S1 is not necessarily formed in the decoloring printing mode of the image processing apparatus 1. For example, the image on the decoloring sheet S1 may be formed with the decolorable recording material by devices other than the image processing apparatus 1 or may be formed by a ballpoint pen using the decolorable recording material. Characters are also one type of the image. The decoloring sheet tray 11a is an example of a second tray.

The printing sheet tray 11b houses a printing sheet S2 used for printing. The user of the image processing apparatus 1 puts a sheet for printing in the printing sheet tray 11b in advance. The printing sheet tray 11b is an example of a first tray.

The sheet feed roller 12a conveys the decoloring sheet S1 housed in the decoloring sheet tray 11a from the decoloring sheet tray 11a.

The sheet feed roller 12b conveys the printing sheet S2 housed in the printing sheet tray 11b from the printing sheet tray 11b.

The sheet detection sensor 13a detects whether or not there is a sheet in the decoloring sheet tray 11a. The sheet detection sensor 13a outputs a detection result.

The sheet detection sensor 13b detects whether or not there is a sheet in the printing sheet tray 11b. The sheet detection sensor 13b outputs a detection result.

The sheet detection sensor 13a and the sheet detection sensor 13b (hereinafter, collectively referred to as a “sheet detection sensor 13”) are, for example, weight sensors for detecting presence of the sheets in the decoloring sheet tray 11a and the printing sheet tray 11b (hereinafter, collectively referred to as a “sheet tray 11”) according to weight. Alternatively, for example, the sheet detection sensor 13 is an optical sensor for detecting presence of the sheet in the sheet tray 11 by using light. The sheet detection sensor 13 may be other well-known sensors capable of detecting the presence of the sheet.

The transfer section 20 transfers the image onto the printing sheet S2 to carry out printing. The transfer section 20 includes a decoloring image forming section 21E, a cyan image forming section 21C, a magenta image forming section 21M, a yellow image forming section 21Y, a black image forming section 21K, a transfer belt 22 and a transfer roller 23.

The decoloring image forming section 21E, the cyan image forming section 21C, the magenta image forming section 21M, the yellow image forming section 21Y and the black image forming section 21K form an image transferred onto the printing sheet S2. The decoloring image forming section 21E is used in the decoloring printing mode. The decoloring image forming section 21E forms an image transferred onto the printing sheet S2 with the decolorable recording material. The cyan image forming section 21C, the magenta image forming section 21M, the yellow image forming section 21Y and the black image forming section 21K are used in the non-decoloring printing mode. The cyan image forming section 21C, the magenta image forming section 21M, the yellow image forming section 21Y and the black image forming section 21K respectively correspond to colors of CMYK. In other words, the cyan image forming section 21C forms an image transferred onto the printing sheet S2 with a cyan non-decolorable recording material. The magenta image forming section 21M forms an image transferred onto the printing sheet S2 with a magenta non-decolorable recording material. The yellow image forming section 21Y forms an image transferred onto the printing sheet S2 with a yellow non-decolorable recording material. The black image forming section 21K forms an image transferred onto the printing sheet S2 with a black non-decolorable recording material. Each image forming section overlaps the image of each color on the transfer belt 22 to transfer the image after the image to be transferred is formed.

The decolorable recording material used by the decoloring image forming section 21E is decolored at a temperature higher than a predetermined temperature. The decolorable recording material becomes an invisible state by being decolored.

The transfer belt 22 is an endless belt and is rotatable by operation of a roller. The transfer belt 22 conveys the image transferred from each image forming section to the transfer roller 23 by rotation.

The transfer roller 23 includes a first roller 23a and a second roller 23b facing each other. The transfer roller 23 transfers an image formed on the transfer belt 22 onto the printing sheet S2.

The heating section 30 carries out fixing of an image transferred onto the sheet. The heating section 30 decolors the image formed on the sheet. The heating section 30 includes a heat roller 31 and a pressure roller 32 facing each other.

The heat roller 31 includes a heat source such as a heater for heating the heat roller 31. The heat roller 31 heats the sheet.

The pressure roller 32 pressurizes the sheet.

The heat roller 31 and the pressure roller 32 fixes the image transferred onto the printing sheet S2 on the printing sheet S2 by heating and pressurizing the printing sheet S2. The heat roller 31 decolors the image formed with the decolorable recording material on the decoloring sheet S1 by heating the decoloring sheet S1.

The heat roller 31 can control a temperature of a part thereof facing the pressure roller 32 and can set the temperature of the part to a set temperature. The heat roller 31 heats the sheet at a temperature in response to each operation mode. The temperature of the heat roller 31 in the decoloring printing mode is referred to as a decoloring printing temperature, the temperature of the heat roller 31 in the non-decoloring printing mode is referred to as a non-decoloring printing temperature, and the temperature of the heat roller 31 in the decoloring mode is referred to as a decoloring temperature. The decoloring printing temperature, the non-decoloring printing temperature and the decoloring temperature have a relationship that (decoloring printing temperature)<(non-decoloring printing temperature)<(decoloring temperature) as an example. The decoloring printing temperature is lower than a temperature at which the decolorable recording material can be decolored, and is 140 degrees centigrade as an example. The non-decoloring printing temperature is 160 degrees centigrade as an example. The decoloring temperature is higher than the temperature at which the decolorable recording material can be decolored, and is 180 degrees centigrade as an example. The heat roller 31 operates to maintain a temperature thereof around a temperature corresponding to the operation mode in each operation mode. The heat roller 31 operates to maintain a temperature thereof in a range of the temperature corresponding to the operation mode ±2˜3 degrees centigrade as an example in each operation mode. Around the decoloring printing temperature and around the non-decoloring printing temperature are examples of a first temperature range. Around the decoloring temperature is an example of a second temperature range. Around the non-decoloring printing temperature is an example of a third temperature range.

The sheet feed section 10, the transfer section 20 and the heating section 30 function as an image processing module.

The operation panel 40 is provided with an input device for receiving an operation by an operator of the image processing apparatus 1. The input device is, for example, a keypad, a touch pad, etc. The operation panel 40 is provided with a display device for displaying a screen for notifying the operator of the image processing apparatus 1 of various information. The display device is a display such as a liquid crystal display or an organic EL (electro-luminescence) display, etc. As the display device, it is also possible to use a display panel laid on the touch pad. A display panel provided in a touch panel can be used as the display device, and a touch pad provided in the touch panel can be used as the input device.

The scanner section 50 is provided with an image capturing element such as a CCD (charge-coupled device) image sensor or a CMOS (complementary metal-oxide-semiconductor) image sensor, etc. The scanner section 50 uses the image capturing element to readout the image from the sheet placed on the scanner section 50.

The image processing apparatus 1 can copy by printing the image read out by the scanner section on the printing sheet S2.

The decoloring sheet S1 and the printing sheet S2 pass through a conveyance route R as shown in FIG. 1 as an example. Hereinafter, a process in which the decoloring sheet S1 or the printing sheet S2 passes through the conveyance route R in each mode is described.

In the decoloring printing mode and the non-decoloring printing mode, the printing sheet S2 conveyed from the printing sheet tray 11b is transmitted to the transfer roller 23. The printing sheet S2 transmitted to the transfer roller 23 passes between the first roller 23a and the second roller 23b. At the time, the image from the transfer belt 22 is transferred onto the printing sheet S2. The printing sheet S2 onto which the image is transferred is sent to the heating section 30 next. The printing sheet S2 sent to the heating section 30 passes through the heat roller 31 and the pressure roller 32. At this time, the printing sheet S2 is heated and pressurized to fix the transferred image. Thereafter, the printing sheet is sent to the outside of a housing of the image processing apparatus 1.

In the decoloring mode, the decoloring sheet S1 conveyed from the decoloring sheet tray 11a is sent to the transfer roller 23. The decoloring sheet S1 sent to the transfer roller 23 passes between the first roller 23a and the second roller 23b without any change to be sent to the heating section 30. The decoloring sheet S1 sent to the heating section 30 passes between the heat roller 31 and the pressure roller 32. At this time, the decoloring sheet S1 is heated at the decoloring temperature to decolor the image. Thereafter, the decoloring sheet S1 is conveyed to the outside of the housing of the image processing apparatus 1.

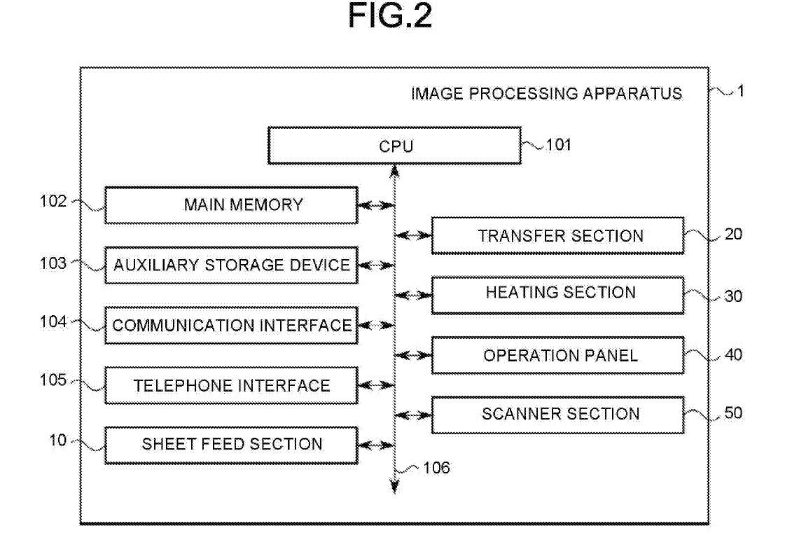

FIG. 2 is a block diagram illustrating the main portion circuit constitution of the image processing apparatus 1 according to the first embodiment.

The image processing apparatus 1 includes, as main portion circuit constitution, a CPU (central processing unit) 101, a main memory 102, an auxiliary storage device 103, a communication interface 104, a telephone interface 105, the sheet feed section 10, the transfer section 20, the heating section 30, the operation panel 40, the scanner section 50 and a bus line 106.

The CPU 101 acts as a central part of a computer for executing a processing and a control necessary for the operation of the image processing apparatus 1. The CPU 101 controls each section to realize various functions of the image processing apparatus 1 based on an operating system or a program such as application software stored in the main memory 102 or the auxiliary storage device 103.

The main memory 102 acts as a main storage part of the above-mentioned computer. The main memory 102 stores the operating system or the program such as the application software in some cases. The main memory 102 stores data temporarily used while the CPU 101 executes various processing, in other words, used as a working area.

The auxiliary storage device 103 acts as an auxiliary storage section of the computer, and the auxiliary storage device 103 is, for example, an EEPROM (electric erasable programmable read-only memory), an HDD (hard disk drive), or an SSD (solid state drive). The auxiliary storage device 103 may store the above operating system or the program such as application software in some cases. The auxiliary storage device 103 stores data used by the CPU 101 to execute various processing or data generated by the processing by the CPU 101. Instead of the auxiliary storage device 103, or in addition to the auxiliary storage device 103, the image processing apparatus 1 may include an interface such as a card slot into which a storage medium such as a memory card can be inserted. The memory card acts as an auxiliary storage part of the computer.

The auxiliary storage device 103 stores a threshold value T11, a value P11 and a value P12. The threshold value T11, the value P11 and the value P12 are typically predetermined by a designer of the image processing apparatus 1. Alternatively, the threshold value T11, the value P11 and the value P12 may be predetermined based on an operation by the operator or an administrator of the image processing apparatus 1. The threshold value T11, the value P11 and the value P12 may be also stored in the main memory 102. Further, the value P11 and the value P12 have the relationship that P11<P12.

The auxiliary storage device 103 stores a job list which is a list of print jobs that is not printed yet. The job list may be also stored in the main memory 102.

The program stored in the main memory 102 or the auxiliary storage device 103 includes a control program described with respect to a control processing described later. As an example, the image processing apparatus 1 is transferred to the administrator, the user, or the like with the control program stored in the main memory 102 or the auxiliary storage device 103. However, the image processing apparatus 1 may be transferred to the administrator, the user, or the like in a state in which the control program described with respect to a control processing described later is not stored in the main memory 102 or the auxiliary storage device 103. The image processing apparatus 1 may also be transferred to the administrator, the user, or the like with another control program stored in the main memory 102 or the auxiliary storage device 103. Then, the control program described with respect to the control processing described later may be separately transferred to the administrator, the user, or the like, and may be written to the auxiliary storage device 103 under the operation of the administrator, the user, a service man or the like. The transfer of the control program at this time can be realized by recording it on a removable recording medium such as a magnetic disk, a magneto-optical disk, an optical disk, a semiconductor memory and the like or by downloading it via a network.

The communication interface 104 is an interface for the image processing apparatus 1 to communicate with other devices via a network (not shown) such as an Internet or a LAN (local area network).

The telephone interface 105 is an interface for the image processing apparatus 1 to communicate via a public switched telephone network (not shown). The telephone interface 105 receives and transmits FAX (facsimile) data and the like.

The bus line 106 includes an address bus line, the data bus line and the like, and transmits signals received and transmitted in each section of the image processing apparatus 1.

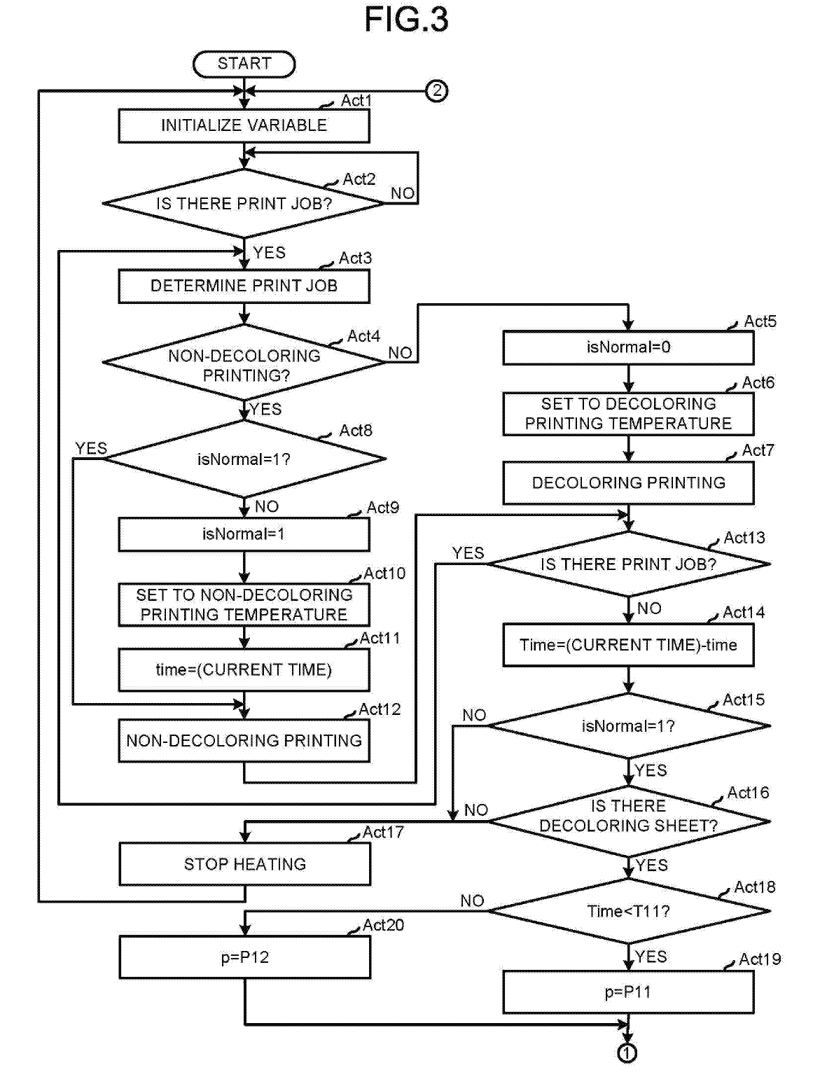

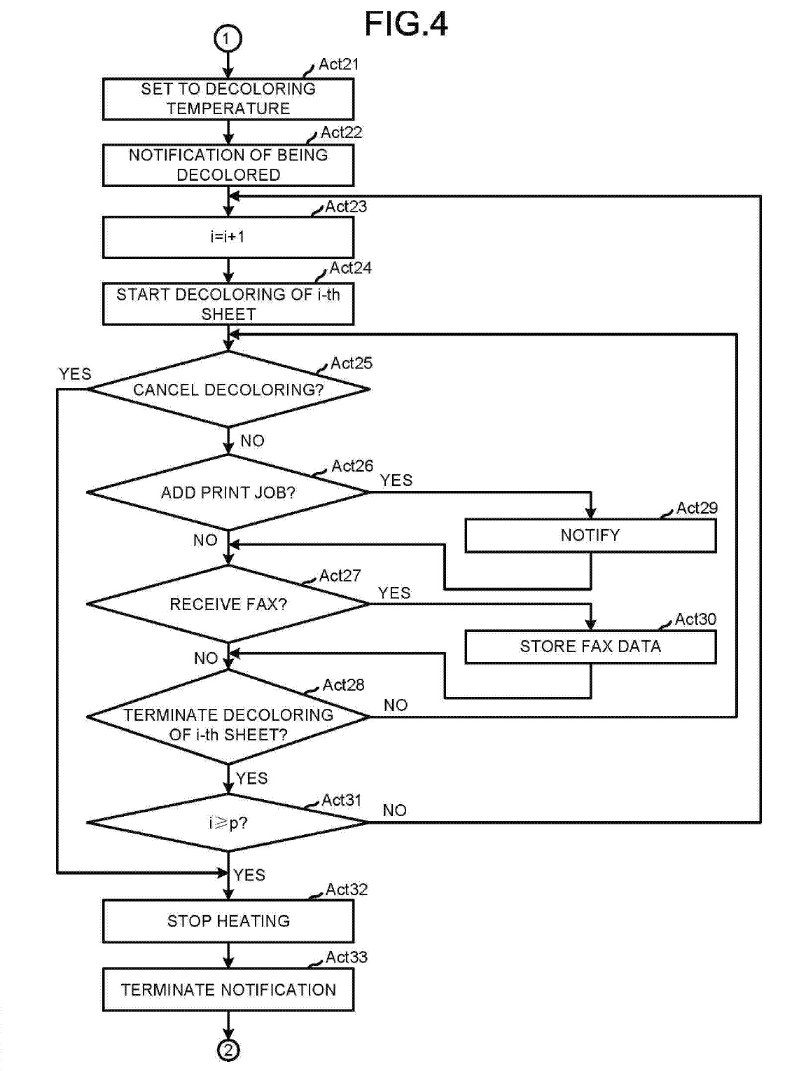

Hereinafter, the operation of the image processing apparatus 1 according to the first embodiment is described with reference to FIG. 3 and FIG. 4. Furthermore, contents of a processing in the following operation description are merely an example, and various processing capable of obtaining the same result can be properly used. FIG. 3 and FIG. 4 are flowcharts of a control processing by the CPU 101 of the image processing apparatus 1. The CPU 101 executes the control processing based on the control program stored in the main memory 102 or the auxiliary storage device 103. The CPU 101 assigns a variable isNormal, a variable time, a variable p and a variable i to the main memory 102 as an example at the time the control processing shown in FIG. 3 is started. The variable isNormal is a flag indicating that the printing is executed in the non-decoloring printing mode. The variable time indicates time when the printing is executed in the non-decoloring printing mode. The variable p indicates the number of the sheets to be decolored by the image processing apparatus 1. The variable i indicates the number of the sheets decolored by the image processing apparatus 1.

In Act 1 in FIG. 3, the CPU 101 of the image processing apparatus 1 initializes the variable isNormal, the variable time and the variable i. The CPU 101 sets values of the variable isNormal, the variable time and the variable i to 0. The CPU 101 proceeds to the processing in Act 2 after the processing in Act 1.

In Act 2, the CPU 101 confirms whether or not there is the print job that is not printed yet. The CPU 101 confirms whether or not there is the print job in the job list. The CPU 101 repeats the processing in Act 2 if there is no print job that is not printed yet. If there is the print job that is not printed yet in a standby state in Act 2, the CPU 101 determines Yes in Act 2 and proceeds to the processing in Act 3.

In Act 3, the CPU 101 determines the print job to be printed later. Generally, the CPU 101 determines a job initially registered among the print jobs registered in the job list as a print job to be printed later. The CPU 101 proceeds to the processing in Act 8 after the processing in Act 3.

In Act 4, the CPU 101 confirms whether or not the print job determined in Act 3 designates a non-decoloring printing. If the print job does not designate the non-decoloring printing, in other words, designates a decoloring printing, the CPU 101 determines No in Act 4 and proceeds to the processing in Act 5.

In Act 5, the CPU 101 sets the value of the variable isNormal to 0. Thus, the variable isNormal indicates that the printing to be printed later is the decoloring printing, and that the printing is also the decoloring printing after the printing is terminated. In other words, the variable isNormal indicates that the printing is executed in the decoloring printing mode. The CPU 101 proceeds to the processing in Act 6 after the processing in Act 5.

In Act 6, the CPU 101 sets the temperature of the heat roller 31 to the decoloring printing temperature. In this way, the temperature of the heat roller 31 is the decoloring printing temperature by the operation of the heater. The image processing apparatus 1 starts the operation in the decoloring printing mode. The CPU 101 proceeds to the processing in Act 7 after the processing in Act 6.

In Act 7, the CPU 101 controls each section to carry out the decoloring printing on the printing sheet S2 based on the content of the print job determined in Act 3. The CPU 101 deletes the print job from the job list after the printing is completed based on the printing job. The CPU 101 proceeds to the processing in Act 13 after the processing in Act 7.

On the other hand, if the print job determined in Act 3 designates the non-decoloring printing, the CPU 101 determines Yes in Act 4 and proceeds to the processing in Act 8.

In Act 8, the CPU 101 confirms whether or not the current non-decoloring printing is executed following the non-decoloring printing according to other printing job. As an example, the CPU 101 confirms whether or not the value of the variable isNormal is 1. If the value of the variable isNormal is not 1, the CPU 101 determines No in Act 8 and proceeds to the processing in Act 9.

In Act 9, the CPU 101 sets the value of the variable isNormal to 1. Thus, the variable isNormal indicates that the printing to be printed later is the non-decoloring printing, and that the printing is non-decoloring printing after the printing is executed. The CPU 101 proceeds to the processing in Act 10 after the processing in Act 9.

In Act 10, the CPU 101 sets the temperature of the heat roller 31 to the non-decoloring printing temperature. Thus, the temperature of the heat roller 31 becomes the non-decoloring printing temperature by the operation of the heater. The image processing apparatus 1 starts the operation in the non-decoloring printing mode. The CPU 101 proceeds to the processing in Act 11 after the processing in Act 10.

In Act 11, the CPU 101 starts a timer for measuring time spent in operating in the non-decoloring printing mode. Alternatively, the CPU 101 resets the timer that is already started. The CPU 101 substitutes the value indicating a current time into the variable time. The CPU 101 proceeds to the processing in Act 12 after the processing in Act 11.

In Act 12, the CPU 101 controls each section to carry out the non-decoloring printing on the printing sheet S2 based on the content of the printing job determined in Act 3. The CPU 101 deletes the printing job from the job list after the printing is completed based on the printing job. The CPU 101 proceeds to the processing in Act 13 after the processing in Act 12.

In Act 13, the CPU 101 confirms whether or not there is the print job that is not printed yet. The CPU 101 confirms whether or not there is the print job in the job list. If there is the print job that is not printed yet, the CPU 101 determines Yes in Act 13 and returns to the processing in Act 3. On the other hand, the CPU 101 determines No in Act 13 and proceeds to the processing in Act 14 if there is no print job that is not printed yet.

In Act 14, the CPU 101 stops the timer for measuring the time spent in operating in the non-decoloring printing mode. The CPU 101 substitutes a value obtained by subtracting the value of the variable time from the value indicating the current time into the variable time. Thus, the variable time indicates the time during which the image processing apparatus 1 continuously operates in the non-decoloring printing mode in a case in which the image processing apparatus 1 operates in the non-decoloring printing mode in the previous printing. The CPU 101 proceeds to the processing in Act 15 after the processing in Act 14.

In Act 15, the CPU 101 confirms whether or not the previous printing is executed in the non-decoloring printing mode. As an example, the CPU 101 confirms whether or not the value of the variable isNormal is 1. If the value of the variable isNormal is 1, the CPU 101 determines Yes in Act 15 and proceeds to the processing in Act 16.

In Act 16, the CPU 101 acquires the detection result output by the sheet detection sensor 13a to confirm whether or not the sheet is housed in the decoloring sheet tray 11a.

If the sheet is not housed in the decoloring sheet tray 11a, the CPU 101 determines No in Act 16 and proceeds to the processing in Act 17. Even if the value of the variable isNormal is 0, the CPU 101 determines No in Act 15 and proceeds to the processing in Act 17.

In Act 17, the CPU 101 stops the heating of the heater of the heat roller 31. The image processing apparatus 1 terminates the operation in the non-decoloring printing mode or the decoloring printing mode. The CPU 101 returns to the processing in Act 1 after the processing in Act 17.

On the other hand, if the sheet is housed in the decoloring sheet tray 11a, the CPU 101 determines Yes in Act 16 and proceeds to the processing in Act 18.

In Act 18, the CPU 101 confirms whether or not the time spent in continuously operating in the non-decoloring printing mode in the previous printing is smaller than a predetermined time. As an example, the CPU 101 confirms whether or not the value of the variable time is smaller than the threshold value T11. If the value of the variable time is smaller than the threshold value T11, the CPU 101 determines Yes in Act 18 and proceeds to the processing in Act 19.

In Act 19, the CPU 101 determines the number of the decoloring sheets S1 on which the image is decolored later to be P11. In other words, as an example, the CPU 101 sets the value of the variable p to the value P11. The CPU 101 proceeds to the processing in Act 21 after the processing in Act 19.

On the other hand, if the value of the variable time is equal to or greater than the threshold value T11, the CPU 101 determines No in Act 18 and proceeds to the processing in Act 20.

In Act 20, the CPU 101 determines the number of the decoloring sheets S1 on which the image is decolored later to be P12. As an example, the CPU 101 sets the value of the variable p to the value P12. The CPU 101 proceeds to the processing in Act 21 in FIG. 4 after the processing in Act 20.

In Act 21, the CPU 101 sets the temperature of the heat roller 31 to the decoloring temperature. Thus, the temperature of the heat roller 31 becomes the decoloring temperature by the operation of the heater. The image processing apparatus 1 starts the operation in the decoloring mode. The CPU 101 proceeds to the processing in Act 22 after the processing in Act 21.

In Act 22, the CPU 101 notifies the operator of the image processing apparatus 1 that the image processing apparatus 1 is operating in the decoloring mode. The CPU 101 displays characters or an image indicating that the image processing apparatus 1 is operating in the decoloring mode on the display device of the operation panel 40 as an example. The CPU 101 proceeds to the processing in Act 23 after the processing in Act 22.

In Act 23, the CPU 101 increases the value of the variable i by 1. The CPU 101 proceeds to the processing in Act 24 after the processing in Act 23.

In Act 24, the CPU 101 starts the decoloring of the i-th decoloring sheet S1. The CPU 101 proceeds to the processing in Act 25 after the processing in Act 24.

In Act 25, the CPU 101 confirms whether or not an instruction to cancel the decoloring is executed. As an example, the operator of the image processing apparatus 1 operates the operation panel 40 to instruct cancel of the decoloring. Alternatively, for example, the cancel of the decoloring is instructed via the network (not shown) from a device (not shown) such as a PC (personal computer) or a server. If the cancel of the decoloring is not instructed, the CPU 101 determines No in Act 25 and proceeds to the processing in Act 26.

In Act 26, the CPU 101 confirms whether or not the print job is newly registered in the job list. The print job is transmitted via the network (not shown) from the device (not shown) such as the PC, for example. The transmitted print job is received by the communication interface 104 of the image processing apparatus 1. In response to reception of the print job, the CPU 101 registers the print job in the job list. Alternatively, for example, the operator of the image processing apparatus 1 operates the operation panel 40 to input the instruction of the printing. The CPU 101 which receives the instruction registers the print job in the job list newly. If the print job is not newly registered in the job list, the CPU 101 determines No in Act 26 and proceeds to the processing in Act 27.

In Act 27, the CPU 101 confirms whether or not the FAX data is received via the telephone interface 105. If the FAX data is not received, the CPU 101 determines No in Act 27 and proceeds to the processing in Act 28.

In Act 28, the CPU 101 confirms whether or not the decoloring of the i-th sheet is terminated. If the decoloring of the i-th sheet is not terminated, the CPU 101 determines No in Act 28 and returns to the processing in Act 25. In this way, the CPU 101 repeats the processing in Act 25˜Act 28, in other words, repeats the determination on whether the cancel of the decoloring is instructed, whether the print job is newly registered, and whether the FAX data is received, until the decoloring of the i-th sheet is terminated.

If the print job is newly registered in the job list in the standby state in Act 25˜Act 28, the CPU 101 determines Yes in Act 26 and proceeds to the processing in Act 29.

In Act 29, the CPU 101 notifies the operator of the image processing apparatus 1 that the image processing apparatus 1 is operating in the decoloring mode and the printing cannot be executed until the operation in the decoloring mode is terminated. In addition, the CPU 101 may also notify the operator of the image processing apparatus 1 that the decoloring can be canceled. Thus, for example, the CPU 101 displays characters and images indicating the above messages on the display device of the operation panel 40. Furthermore, for example, the CPU 101 instructs the communication interface 104 to transmit a command indicating the above messages to a device which is a transmission source of the print job. The device receiving the command displays a screen showing the above messages. The screen includes a cancel button for instructing the image processing apparatus 1 to cancel the decoloring as an example. The communication interface 104 receiving the instruction transmits the command to the corresponding device. The CPU 101 proceeds to the processing in Act 27 after the processing in Act 29.

If the FAX data is received in the standby state in Act 25˜Act 28, the CPU 101 determines Yes in Act 27 and proceeds to the processing in Act 30.

In Act 30, the CPU 101 stores the received FAX data in the main memory 102 or the auxiliary storage device 103. Further, the CPU 101 registers the print job in the job list based on the FAX data to print the FAX data later. The CPU 101 proceeds to the processing in Act 28 after the processing in Act 30.

In Act 31, the CPU 101 confirms whether or not the number of the sheets the decoloring of which is completed reaches the determined number in Act 19 or Act 20. The CPU 101 confirms whether or not the number of the sheets the decoloring of which is completed is equal to or greater than the value of the variable p. The CPU 101 determines No in Act 31 and returns to the processing in Act 23 if the value of the variable i is not equal to or greater than the value of the variable p. In this way, the CPU 101 repeats the processing in Act 23˜Act 31 until the number of the sheets the decoloring of which is completed is equal to or greater than the value of the variable p.

If the number of the sheets the decoloring of which is completed is equal to or greater than the value of the variable p, the CPU 101 determines Yes in Act 31 and proceeds to the processing in Act 32.

If the instruction of the cancel of the decoloring is executed in the standby state in Act 25˜Act 31, the CPU 101 determines Yes in Act 25 and proceeds to the processing in Act 32.

In Act 32, the CPU 101 stops the heating of the heater of the heat roller 31. The image processing apparatus 1 terminates the operation in the decoloring mode. The CPU 101 proceeds to the processing in Act 33 after the processing in Act 32.

In Act 33, the CPU 101 terminates the notification if the notification executed in Act 22 or Act 29 is continued. The CPU 101 returns to the processing in Act 1 in FIG. 3 after the processing in Act 33.

From the above, by executing the processing shown in FIG. 3 and FIG. 4, the computer taking the CPU 101 as the center part functions as a control module for controlling the execution of several modes. Thus, the computer taking the CPU 101 as the center part is an example of the control device.

According to the image processing apparatus 1 of the first embodiment, the CPU 101 controls the execution of the decoloring operation after the printing is executed. At the time the image processing apparatus 1 executes the printing, the heat roller 31 is heated to the decoloring printing temperature or the non-decoloring printing temperature to fix the image. Thus, the heating section 30 after the printing has the higher temperature than that at the time the image processing apparatus 1 does not operate. Thus, less amount of heat necessary to increase the temperature of the heat roller 31 to the decoloring temperature and less amount of heat necessary to maintain the temperature of the heat roller 31 at the decoloring temperature is required. By the control of the CPU 101, the image processing apparatus 1 is excellent in efficient use of the energy at the time the image is decolored compared with the conventional image processing apparatus. Further, by the control of the CPU 101, the image processing apparatus 1 can increase the temperature of the heat roller 31 to the decoloring temperature in a shorter time compared with the conventional image processing apparatus.

According to the image processing apparatus 1 of the first embodiment, the CPU 101 controls the execution of the decoloring operation after the non-decoloring printing is executed. At the time the image processing apparatus 1 executes the non-decoloring printing, the heat roller 31 is heated to the non-decoloring printing temperature. Generally, the non-decoloring printing temperature is higher than the decoloring printing temperature. Thus, the amount of heat necessary to increase the temperature of the heat roller 31 to the decoloring temperature and the amount of heat necessary to maintain the temperature of the heat roller 31 at the decoloring temperature is less in the case in which the decoloring operation is executed after the non-decoloring printing when compared with a case in which the decoloring printing is directly executed. Thus, by the control of the CPU 101, the image processing apparatus 1 is excellent in efficient use of the energy at the time the image is decolored compared with the conventional image processing apparatus. Further, by the control of the CPU 101, the image processing apparatus 1 can increase the temperature of the heat roller 31 to the decoloring temperature in a shorter time compared with the conventional image processing apparatus.

According to the image processing apparatus 1 of the first embodiment, the CPU 101 determines the number of sheets to be decolored by setting the time during which the non-decoloring printing is executed as a condition. It is considered that the more amount of heat is stored in the image processing apparatus 1 if the time during which the non-decoloring printing is performed is longer. Therefore, the image processing apparatus 1 decolors the large number of the decoloring sheets S1 if the time during which the non-decoloring printing is performed is long, in other words, large amount of heat stored. By the operation as stated above, it is considered that less amount of heat required to maintain the temperature of the heat roller 31 to the decoloring temperature is required. Therefore, by the control of the CPU 101, the image processing apparatus 1 is superior in the efficient use of the energy at the time of decoloring the image compared with the conventional image processing apparatus.

### Second Embodiment

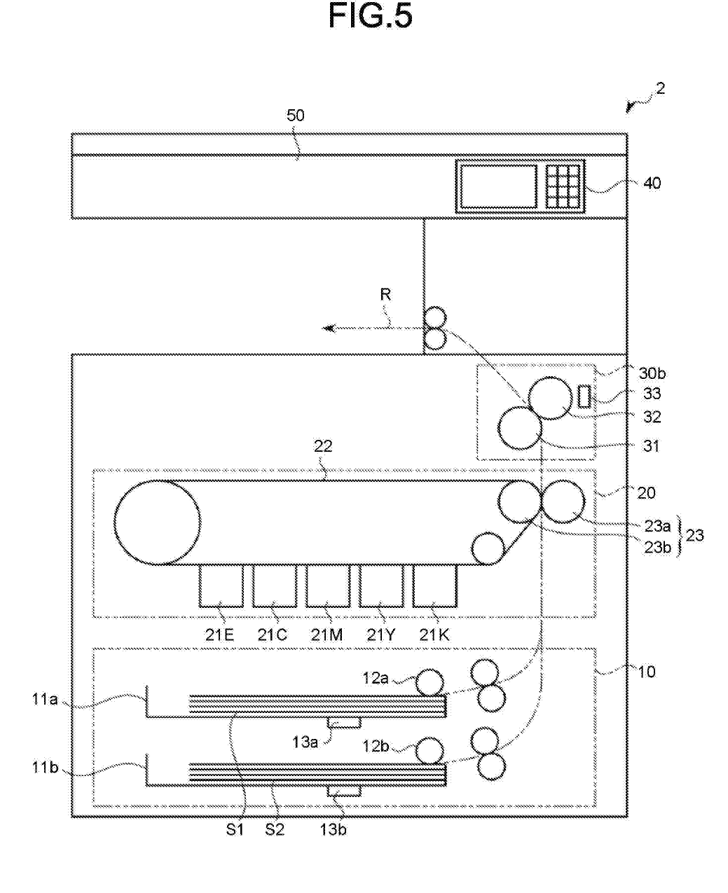

FIG. 5 is a pattern view illustrating the main portion constitution of an image processing apparatus 2 according to the second embodiment. The same components as those in FIG. 1 are donated with the same reference numerals as those in FIG. 1. The description of the same components as those in FIG. 1 is omitted in some cases.

The image processing apparatus 2 is provided with a heating section 30b instead of the heating section 30. The heating section 30b includes a thermometer 33 in addition to the heat roller 31 and the pressure roller 32. The heating section 30b may be the same as the heating section 30 except that the heating section 30b includes the thermometer 33.

The thermometer 33 measures the temperature of the heating section 30b. The thermometer 33 measures air temperature of the periphery of the heat roller 31 in the heating section 30b. Alternatively, for example, the thermometer 33 measures the temperature of members near the heat roller 31. Alternatively, for example, the thermometer 33 measures the temperature of the heat roller 31 other than a part facing the pressure roller 32. Since the part is controlled to be maintained around the set temperature, it is considered that the temperature change is small. Alternatively, for example, the thermometer 33 may also measure the temperature on a route through which the exhaust heat of the heating section 30b passes.

The thermometer 33 outputs the measured temperature as temperature data. The temperature measured by the thermometer 33 is an example of the environmental temperature.

Since the image processing apparatus 2 is the same as the image processing apparatus 1 of the first embodiment regarding the main portion circuit constitution, the description thereof is omitted. However, the image processing apparatus 2 includes the heating section 30b instead of the heating section 30 as a main portion circuit constitution.

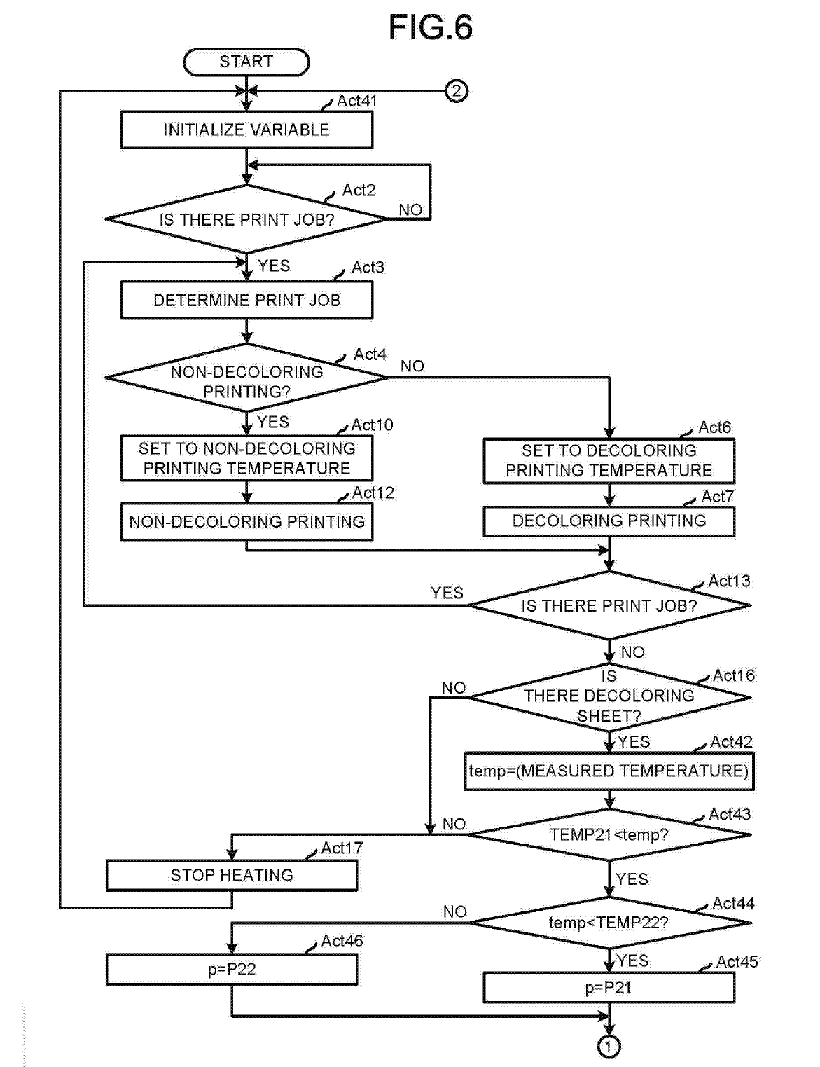

The main memory 102 or the auxiliary storage device 103 of the second embodiment is different from that of the first embodiment in that the main memory 102 or the auxiliary storage device 103 stores a program described with respect to a control processing in FIG. 6 instead of the control program described with respect to the control processing shown in FIG. 3. The main memory 102 or the auxiliary storage device 103 of the second embodiment also stores the control program described with respect to the control processing shown in FIG. 4, which is the same as that of the first embodiment.

The main memory 102 or the auxiliary storage device 103 of the second embodiment stores a threshold value TEMP21 and a threshold value TEMP22 instead of the threshold value T11 and a value P21 and a value P22 instead of the value P11 and the value P12. The threshold value TEMP21 is typically predetermined by, for example, a designer of the image processing apparatus 2. Alternatively, the threshold value TEMP21 may also be predetermined based on an operation by an operator or an administrator of the image processing apparatus 2. The threshold value TEMP21 and the threshold value TEMP22 are in the relationship of TEMP21<TEMP22. The value P21 and the value P22 are in the relationship of P21<P22.

Hereinafter, the operation of the image processing apparatus 2 according to the second embodiment is described with reference to FIG. 6 and FIG. 4. Furthermore, the content of the processing in the following operation description is merely an example, and various processing capable of obtaining the same result can be properly used. FIG. 6 is a flowchart illustrating a control processing according to the second embodiment by the CPU 101 of the image processing apparatus 2. Furthermore, the same components in FIG. 6 as those in FIG. 3 are donated with the same reference numerals as those in FIG. 3. The CPU 101 executes a control processing shown in FIG. 6 based on the control program stored in the main memory 102 or the auxiliary storage device 103. At the time of starting the control processing shown in FIG. 6, the CPU 101 assigns the variable temp, the variable p and the variable i to the main memory 102 as an example. The variable p indicates the number of sheets to be decolored by the image processing apparatus 2. The variable i indicates the number of sheets decolored by the image processing apparatus 2.

In the second embodiment, the CPU 101 executes the processing in Act 5, Act 8, Act 9, Act 11, Act 14 and Act 15 different from the first embodiment. If No in Act 4 in FIG. 6 is determined, the CPU 101 proceeds to the processing in Act 6. If Yes in Act 4 is determined, the CPU 101 proceeds to the processing in Act 10. The CPU 101 proceeds to the processing in Act 12 after the processing in Act 10. If No in Act 13 is determined, the CPU 101 proceeds to the processing in Act 16.

In the second embodiment, the CPU 101 carries out the processing in Act 41 instead of the processing in Act 1.

In Act 41 in FIG. 6, the CPU 101 initializes the variable temp and the variable i. The CPU 101 sets the value of the variable temp and the value of the variable i to 0.

In the second embodiment, the CPU 101 executes the processing in Act 42˜Act 46 instead of the processing in Act 18˜Act 20.

The CPU 101 substitutes the temperature output by the thermometer 33 in Act 42 in FIG. 6 into the variable temp. The CPU 101 proceeds to the processing in Act 43 after the processing in Act 42.

The CPU 101 confirms whether or not the temperature of the heating section 30b in Act 43 is equal to greater than the threshold value TEMP21. As an example, the CPU 101 confirms whether or not the value of the variable temp is equal to or greater than the threshold value TEMP21. The processing is executed so as not to switch to the decoloring mode in a case in which the heating section 30b does not have sufficient amount of heat. If the value of the variable temp is smaller than the threshold value TEMP21, the CPU 101 determines No in Act 43 and proceeds to the processing in Act 17.

On the other hand, if the value of the variable temp is equal to or greater than the threshold value TEMP21, the CPU 101 determines Yes in Act 43 and proceeds to the processing in Act 44.

The CPU 101 confirms whether or not the temperature output by the thermometer 33 is smaller than the threshold value TEMP22 in Act 44. If the temperature output by the thermometer 33 is smaller than the threshold value TEMP22, the CPU 101 determines Yes in Act 44 and proceeds to the processing in Act 45.

In Act 45, the CPU 101 determines the number of the decoloring sheets S1 to be decolored later to P21. As an example, the CPU 101 sets the value of the variable p to the value P21. The CPU 101 proceeds to the processing in Act 21 in FIG. 4 after the processing in Act 45.

If the temperature output by the thermometer 33 is equal to greater than the threshold value TEMP22, the CPU 101 determines No in Act 44 and proceeds to the processing in Act 46.

In Act 46, the CPU 101 determines the number of the decoloring sheets S1 to be decolored later to P22. As an example, the CPU 101 sets the value of the variable p to the value P22. The CPU 101 proceeds to the processing in Act 21 in FIG. 4 after the processing in Act 46.

Through the above, by executing the processing shown in FIG. 6 and FIG. 4, the computer taking the CPU 101 as the center part functions as the control module for controlling the execution of several modes.

According to the image processing apparatus 2 of the second embodiment, the CPU 101 determines the temperature of the heating section 30b as a condition to determine the number of sheets to be decolored. It is considered that the amount of heat stored in the heating section 30b is large as the temperature of the heating section 30b becomes high. Thus, the image processing apparatus 2 decolors a large number of the decoloring sheets S1 if the temperature of the heating section 30b is high, in other words, large amount of heat is stored in the heating section 30b. By the operation as stated above, it is considered that less amount of heat necessary to maintain the temperature of the heat roller 31 at the decoloring temperature is required. By the control of the CPU 101, the image processing apparatus 2 is excellent in efficient use of the energy at the time the image is decolored compared with the conventional image processing apparatus.

The above embodiment may also be modified as follows.

In the first embodiment, the image processing apparatus 1 executes the operation in the decoloring mode after operating in the non-decoloring printing mode in a case in which the operation in the non-decoloring printing mode is executed. The image processing apparatus 1 determines the number of sheets p to be decolored in response to the time during which the operation in the non-decoloring mode is executed. However, the image processing apparatus 1 may also operate in the decoloring mode after operating in the decoloring printing mode even in a case in which the operation in the decoloring printing mode is executed. In this case, The CPU 101 determines the number of sheets p to be decolored based on the total time of the non-decoloring printing mode and the decoloring printing mode. As an example, the CPU 101 executes the same processing as that in Act 11 after the processing in Act 6. The CPU 101 skips the processing in Act 11 if the value of the variable time is not 0 in Act 11. Further, the CPU 101 skips the processing in Act 15 and proceeds to the processing in Act 16 after the processing in Act 14.

The image processing apparatus may also enable the operation in the printing mode in a state in which the decolorable recording material and the non-decolorable recording material are mixed. In this case, the image processing apparatus 1 or the image processing apparatus 2 may operate in the decoloring mode after operating in this mode which is an example of the print mode. The temperature of the heat roller 31 that is set at the time of operating in that mode is an example of the first temperature range.

The image processing apparatus is not limited to the decoloring printing mode or the non-decoloring printing mode, but may also execute the operation in the decoloring mode after executing other operations such as increasing the temperature of the heating section.

In the first embodiment, the image processing apparatus 1 determines the number of sheets p to be decolored from the two values P11 and P12 depending on whether the time spent in operating in the non-decoloring printing mode is equal to or greater than the threshold value T11. However, the image processing apparatus 1 may store a plurality of the threshold values to determine the number of the sheets to be decolored from three or more values. For example, by setting threshold values T31<T32<T33< . . . and values P31<P32<P33< . . . , the CPU 101 may determine that in a case in which time<T31, p=P31; in a case in which T31<time<T32, p=P32; in a case in which T32<time<T33,p=P33; . . . . Furthermore, the threshold values T31, T32, T33, . . . and the values P31, P32, P33 . . . , are predetermined values similar to the threshold value T11 and the values P11 and P12.

In the second embodiment, the image processing apparatus 2 determines the number of sheets p to be decolored from the two values P21 and P22 depending on whether the measured temperature is equal or greater than the threshold value TEMP22. However, the image processing apparatus 2 may store a plurality of the threshold values to determine the number of the sheets to be decolored from three or more values. For example, by setting threshold values TEMP41<TEMP42<TEMP43<TEMP44< . . . and values P41<P42<P43< . . . , the CPU 101 may determine that in a case in which TEMP41<temp<TEMP42, p=P41; in a case in which TEMP42<temp<TEMP43, p=P42; and in a case in which TEMP43<time<TEMP44, p=P43. Furthermore, the threshold values TEMP41, TEMP42, TEMP43, TEMP44, . . . and the values P41, P42, P43, . . . are predetermined similar to the threshold values TEMP21 and TEMP22 and the values P21 and P22.

In the first embodiment, the image processing apparatus 1 determines the number of sheets p to be decolored from the two values P11 and P12 depending on whether the time spent in operating in the non-decoloring printing mode is equal to or greater than the threshold value T11. However, the image processing apparatus 1 may set the number of the sheets to be decolored to a fixed number regardless of the value of time. As an example, the CPU 101 substitutes a value P51 into the variable p after the processing in Act 16 in FIG. 3. Then, the CPU 101 proceeds to the processing in Act 21 in FIG. 4. The value P51 is predetermined similar to the values P11 and P12.

In the second embodiment, the image processing apparatus 2 determines the number of sheets p to be decolored from the two values P21 and P22 depending on whether the measured temperature is equal to or greater than the threshold value TEMP22. However, if the measured temperature is equal to or greater than the threshold value TEMP21, the image processing apparatus 2 may set the number of sheets to be decolored to a fixed number regardless of the value of temp. As an example, if Yes in Act 43 in FIG. 6 is determined, the CPU 101 substitutes a value 61 into the variable p. Then, the CPU 101 proceeds to the processing in Act 21 in FIG. 4. The value P61 is predetermined similar to the values P21 and P22.

In the first embodiment and the second embodiment, the image processing apparatus determines the number of sheets p to be decolored according to the threshold value. However, the CPU 101 may determine the number of sheets to be decolored based on a predetermined function. As an example, the CPU 101 determines the number of sheets to be decolored by setting p=f(time) or p=g (temp) based on a predetermined function f(time) of time or a predetermined function g (temp) of temp.

The image processing apparatus may carry out decoloring unlimitedly without determining the number of sheets to be decolored. As an example, the CPU 101 carries out the same processing as that in Act 16 instead of the processing in Act 31 in FIG. 4. If the sheet is not housed in the decoloring sheet tray 11a, the CPU 101 proceeds to the processing in Act 32; contrarily, if the sheet is housed in the decoloring sheet tray 11a, the CPU 101 returns to the processing in Act 23.

In the first embodiment and the second embodiment, the image processing apparatus determines the number of sheets p to be decolored as an amount of operation in the decoloring mode. However, the image processing apparatus may determine the decoloring time instead of the number of sheets p to be decolored as the amount of the operation in the decoloring mode. The image processing apparatus operates in the decoloring mode until the determined time passes during which the decoloring sheet S1 is decolored one after another.

In the image processing apparatus, the number of sheets to be decolored may be changed according to a size of the decoloring sheet S1. The image processing apparatus decreases the number of sheets to be decolored as the size of the decoloring sheet S1 increases.

In the first embodiment, the image processing apparatus 1 determines the number of sheets p to be decolored based on the time spent in operating in the non-decoloring printing mode. However, the image processing apparatus 1 may determine the number of sheets p to be decolored based on the number of sheets printed in the non-decoloring printing mode.

In the first embodiment and the second embodiment, the image processing apparatus starts the next decoloring each time the decoloring of one sheet finishes. However, the decoloring sheet S1 may be sequentially discharged from the decoloring sheet tray 11a to be successively decolored.

In the first embodiment and in the second embodiment, the sheet to be decolored is placed in the decoloring sheet tray 11a. However, the sheet that is desired to be decolored may be placed in other trays such as a manual feed tray. In this case, the image processing apparatus conveys the sheet from the corresponding tray to the heating section.

The image processing apparatus may operate in two operation modes including either the decoloring printing mode or the non-decoloring printing mode and the decoloring mode.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. The image processing apparatus of claim 10, wherein
the control module controls a heater to a first temperature range in response to designation of a print mode to execute the print mode in which the image is formed with a non-decolorable first recording material or a decolorable second recording material on the sheet and the image is fixed on the sheet with the heater; and
the control module controls the heater to a second temperature range higher than the first temperature range in response to an execution state of the print mode to execute an erasing mode in which an image formed with the second recording material is erased by heating of the heater.

2. The image processing apparatus according to claim 1, wherein
the control module controls the heater to a third temperature range contained in the first temperature range in response to designation of a non-decoloring printing mode as the print mode, and executes the non-decoloring printing mode in which an image is formed with the first recording material and the image is fixed on the sheet by the heater.

3. The image processing apparatus according to claim 1, wherein
the control module instructs an amount of operation in the erasing mode according to execution time of the print mode.

4. The image processing apparatus according to claim 2, wherein
the control module instructs an amount of operation in the erasing mode according to execution time of the print mode.

5. The image processing apparatus according to claim 1, wherein
the control module instructs an amount of operation in the erasing mode according to environmental temperature due to execution of the print mode.

6. The image processing apparatus according to claim 2, wherein
the control module instructs an amount of operation in the erasing mode according to environmental temperature due to execution of the print mode.

7. An image processing apparatus, comprising:
a control module configured to control execution of several modes, and
an image processing module configured to supply a sheet in a first tray according to execution of a print mode to form an image on the sheet with a first recording material or a second recording material, and supply a sheet in a second tray according to execution of an erasing mode to erase the image formed with the second recording material from the sheet, wherein
the control module controls a heater to a first temperature range in response to designation of the print mode to execute the print mode in which an image is formed with the non-decolorable first recording material or the decolorable second recording material on the sheet and the image is fixed on the sheet with the heater;
the control module controls the heater to a second temperature range higher than the first temperature range in response to an execution state of the print mode to execute the erasing mode in which an image formed with the second recording material is erased by heating of the heater; and
the control module controls execution of decoloring the image formed on the sheet of a sheet tray after the image processing apparatus formed the image if a sheet detector detects the sheet is presence in the sheet tray.

8. The method facilitating image processing according to claim 9, further comprising
controlling a heater to a first temperature range in response to designation of a print mode to execute the print mode in which the image is formed with a non-decolorable first recording material or a decolorable second recording material on the sheet and the image is fixed on the sheet with the heater; and
controlling the heater to a second temperature range higher than the first temperature range in response to an execution state of the print mode to execute an erasing mode in which an image formed with the second recording material is erased by heating of the heater.

9. A method facilitating image processing, comprising:
operating in a decolorable recording mode which transfers an image on a sheet with decolorable material and in a non-decolorable recording mode which forms the image on the sheet with non-decolorable material;
fixing the image and decoloring the image formed on the sheet;
detecting the sheet in a sheet tray; and
controlling execution of decoloring the image formed on the sheet of the sheet tray after the image processing apparatus formed the image if the sheet detector detects the sheet is presence in the sheet tray.

10. An image processing apparatus, comprising:
a transfer section operates in a decolorable recording mode which transfers an image on a sheet with decolorable material and in a non-decolorable recording mode which forms the image on the sheet with non-decolorable material;
a heating section fixes the image and decolors the image formed on the sheet;
a sheet detector detects the sheet in a sheet tray; and
a control module controls execution of decoloring the image formed on the sheet of the sheet tray after the image processing apparatus formed the image if the sheet detector detects the sheet is presence in the sheet tray.
